(19) United States
(12) Patent Application Publication
(10) Pub. No.: US 2024/0025111 A1
(43) Pub. Date: Jan. 25, 2024

(54) MANUFACTURING METHOD OF THREE-DIMENSIONAL OBJECT

(71) Applicant: Sodick Co., Ltd., Kanagawa (JP)

(72) Inventor: Hiroshi AMIOKA, Kanagawa (JP)

(73) Assignee: Sodick Co., Ltd., Kanagawa (JP)

(21) Appl. No.: 18/349,922

(22) Filed: Jul. 10, 2023

(30) Foreign Application Priority Data
Jul. 22, 2022 (JP) 2022-117266

(51) Int. Cl. B29C 64/153; B29C 64/268; B29C 64/393; B33Y 10/00; B33Y 50/02

(52) U.S. Cl. CPC B29C 64/153; B29C 64/268; B29C 64/393; B33Y 10/00; B33Y 50/02

(57) ABSTRACT

A manufacturing method of a three-dimensional object includes: a solidified layer forming step of repeating a material layer forming step and a solidification step and laminating a solidified layer; a manufacturing condition setting step of setting an irradiation condition and a division width; an irradiation area determining step of determining an irradiation area for each divided layer obtained by dividing a three-dimensional shape; a dividing step of dividing the irradiation area by the division width along a division direction and forming a divided area; and a scan line setting step of setting a raster scan line within the divided area. A laser beam is scanned along a scan path including the raster scan line. A direction obtained by horizontally rotating the division direction of the irradiation area in a target divided layer is taken as the division direction in the divided layer directly above the target divided layer.

### CROSS-REFERENCE TO RELATED APPLICATION

This application claims the priority benefit of Japanese patent application serial No. 2022-117266, filed on Jul. 22, 2022. The entirety of the above-mentioned patent application is here by incorporated by reference herein and made a part of this specification.

### BACKGROUND

### Technical Field

The disclosure relates to a manufacturing method of a three-dimensional object.

### Related Art

Various methods are known as an additive manufacturing method of a three-dimensional object. For example, in an additive manufacturing apparatus that performs powder bed fusion, a material layer made of material powder is formed in a build area. By irradiating a predetermined position in the material layer with a laser beam or an electron beam, the material layer is sintered or melted, and a solidified layer is formed. By repeatedly forming the material layer and the solidified layer, the solidified layer is laminated, and a desired three-dimensional object is produced.

The laser beam or electron beam is scanned, for example, along so-called raster scan lines which are scanning patterns arranged linearly side by side within an irradiation area in the material layer. Here, there is a case where the irradiation area may be divided by a predetermined division width and raster scanning may be performed for each divided area. In the case where raster scanning is performed for each divided area, since the raster scan lines in each divided area are basically of the same length in accordance with the predetermined division width, the material layer can be melted and solidified with uniform irradiation energy without changing an irradiation condition. Hence, the amount of spatters scattered is reduced, and pinholes or voids are less likely to occur. Since a reference length of the raster scan line that depends on the predetermined division width is as small as several centimeters, even if the laser beam or electron beam is scanned at high speed, adverse effects such as heat on the surroundings can be minimized. Hence, a required pause time can be made relatively short, and melting and solidification can be performed at high speed and with stable quality in which a difference in height between irregularities is small. Japanese Patent No. 6266040 discloses an additive manufacturing apparatus in which, by raster scanning each divided area with a laser beam having an elongated spot shape, the material layer can be uniformly heated and manufacturing quality can be improved.

If raster scanning is performed without dividing the irradiation area, since the raster scan line that determines the irradiation condition has a long reference length, a difference in length between each raster scan line has a relatively small effect on a shape difference of an edge portion of the irradiation area. On the other hand, if raster scanning is performed for each divided area, each raster scan line is set as a straight line basically having the same length as the predetermined division width. At this time, a raster scan line shorter than the division width inevitably occurs at an end of the irradiation area. Since the reference length of the raster scan line is clearly shorter than that in the case where raster scanning is performed without dividing the irradiation area, and the reference length of the raster scan line is set based on the irradiation condition including irradiation energy, in a portion irradiated according to the raster scan line shorter than the reference length, a melt pool formed by irradiation has a relatively high temperature. When the portion irradiated according to a short raster scan line is repeated in a vertical direction as the solidified layer is laminated, a bulge is gradually increased in size by accumulation of many layers of deformation of the solidified layer for each layer, finally leading to a collision with a blade of a material layer forming device that forms the material layer.

The material layer forming device, while moving across the build area and supplying the material powder, levels the material powder with the blade to form the material layer. Hence, when the blade of the material layer forming device collides with the bulge, the amount of the material powder supplied may change and the material layer may become non-uniform, and manufacturing quality may deteriorate. Depending on the size of the bulge, the blade may remain in collision with the bulge and become unable to move, and the manufacturing work may be unable to continue unless the bulge is removed.

### SUMMARY

According to the disclosure, the following aspects are provided. A manufacturing method of a three-dimensional object includes: a solidified layer forming step of laminating a solidified layer by repeating a material layer forming step and a solidification step, the material layer forming step including supplying material powder to a build area and forming a material layer, the solidification step including forming the solidified layer by irradiating a predetermined irradiation area in the material layer with a laser beam or an electron beam; a manufacturing condition setting step of setting an irradiation condition of the laser beam or the electron beam and a division width of the irradiation area; an irradiation area determining step of determining the irradiation area for each of a plurality of divided layers obtained by dividing a desired three-dimensional shape every predetermined height; a dividing step of dividing the irradiation area of each of the plurality of divided layers along a predetermined division direction by the division width suitable for the irradiation condition and forming a plurality of divided areas; and a scan line setting step of setting a raster scan line along a predetermined scanning direction within the plurality of divided areas. In the solidification step, the laser beam or the electron beam is scanned along a scan path including the raster scan line. In the dividing step, a direction obtained by horizontally rotating the division direction of the irradiation area in a target divided layer by a rotation angle θ is taken as the division direction of the irradiation area in the divided layer directly above the target divided layer. The rotation angle θ satisfies 0°<θ<180° or −180°<θ<0° (where a sign indicates a rotation direction).

### BRIEF DESCRIPTION OF THE DRAWINGS

FIG. 1 is a schematic configuration diagram of an additive manufacturing apparatus 100 according to an embodiment of the disclosure.

FIG. 2 is a perspective view of a material layer forming device 3.

FIG. 3 is a perspective view from above of a recoater head 11.

FIG. 4 is a perspective view from below of the recoater head 11.

FIG. 5 is a schematic configuration diagram of an irradiator 13.

FIG. 6 is a block diagram of a control system of the additive manufacturing apparatus 100.

FIG. 7A and FIG. 7B are explanatory diagrams of raster scanning, in which FIG. 7A illustrates raster scanning by an area non-dividing method, and FIG. 7B illustrates raster scanning by an area dividing method.

FIG. 8 illustrates a manufacturing method of a three-dimensional object using the additive manufacturing apparatus 100.

FIG. 9 illustrates a manufacturing method of a three-dimensional object using the additive manufacturing apparatus 100.

FIG. 10 illustrates an irradiation area Sₖ, a divided area, and a raster scan line in a k-th divided layer Lₖ of an exemplary three-dimensional object.

FIG. 11 illustrates an irradiation area Sₖ₊₁, a divided area, and a raster scan line in a (k+1)-th divided layer Lₖ₊₁ of an exemplary three-dimensional object.

FIG. 12 is a perspective view of a three-dimensional object divided into n layers horizontally.

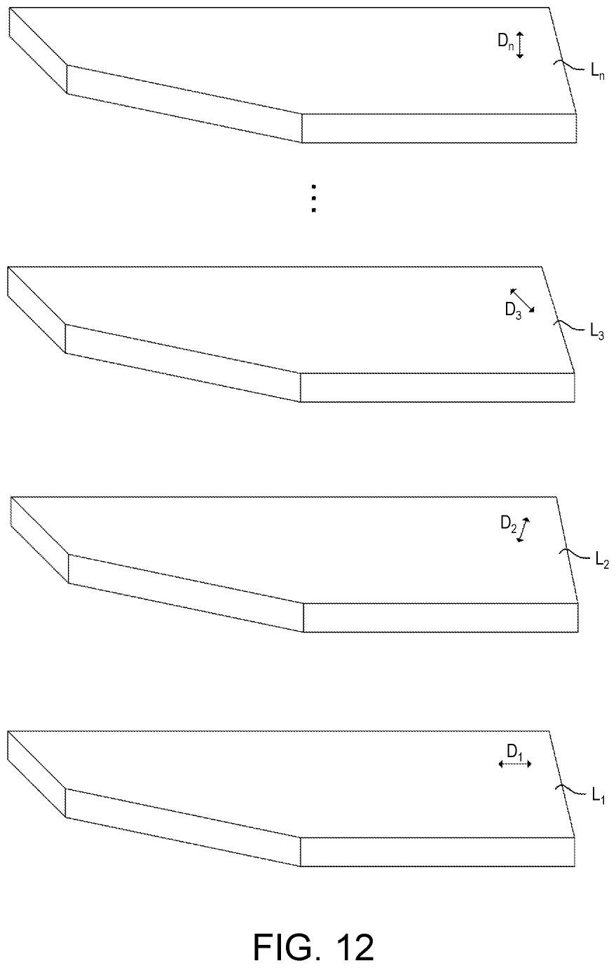

### DESCRIPTION OF THE EMBODIMENTS

The disclosure provides a manufacturing method of a three-dimensional object, in which high-quality manufacturing of a three-dimensional object is possible.

According to the disclosure, the following aspects are provided.
[1] A manufacturing method of a three-dimensional object includes: a solidified layer forming step of laminating a solidified layer by repeating a material layer forming step and a solidification step, the material layer forming step including supplying material powder to a build area and forming a material layer, the solidification step including forming the solidified layer by irradiating a predetermined irradiation area in the material layer with a laser beam or an electron beam; a manufacturing condition setting step of setting an irradiation condition of the laser beam or the electron beam and a division width of the irradiation area; an irradiation area determining step of determining the irradiation area for each of a plurality of divided layers obtained by dividing a desired three-dimensional shape every predetermined height; a dividing step of dividing the irradiation area of each of the plurality of divided layers along a predetermined division direction by the division width suitable for the irradiation condition and forming a plurality of divided areas; and a scan line setting step of setting a raster scan line along a predetermined scanning direction within the plurality of divided areas. In the solidification step, the laser beam or the electron beam is scanned along a scan path including the raster scan line. In the dividing step, a direction obtained by horizontally rotating the division direction of the irradiation area in a target divided layer by a rotation angle θ is taken as the division direction of the irradiation area in the divided layer directly above the target divided layer. The rotation angle θ satisfies 0°<θ<180° or −180°<θ<0° (where a sign indicates a rotation direction).
[2] In the manufacturing method of a three-dimensional object described in [1], in the scan line setting step, the scanning direction is set parallel to the division direction.
[3] The manufacturing method of a three-dimensional object described in [1] or [2] further includes a length determining step of determining whether the scan path on the target divided layer includes the raster scan line of less than a predetermined value. In the case where it is determined in the length determining step that the scan path on the target divided layer includes the raster scan line of less than the predetermined value, in the dividing step, the direction obtained by horizontally rotating the division direction of the irradiation area in the target divided layer by the rotation angle θ is taken as the division direction of the irradiation area in the divided layer directly above the target divided layer.
[4] The manufacturing method of a three-dimensional object described in any one of [1] to [3] further includes a rotation angle setting step of setting the rotation angle θ based on a machining condition. The machining condition includes at least one of the division width, material of the material powder, a condition of the irradiation area, and the irradiation condition.

In the manufacturing method of a three-dimensional object according to the disclosure, the direction obtained by horizontally rotating the division direction of the irradiation area in an arbitrary target material layer by the predetermined rotation angle θ (0°<θ<180° or −180°<θ<0°) is taken as the division direction of the irradiation area in the material layer directly above the target material layer. Rotation of the division direction reduces repetition of a portion irradiated according to a short raster scan line in a vertical direction, and it is possible to suppress formation of bulges in the solidified layer and deterioration of manufacturing quality.

Hereinafter, an embodiment of the disclosure will be described with reference to the drawings. Various characteristics described in the embodiment below can be combined with each other. The disclosure is independently established for each characteristic.

### 1. Additive Manufacturing Apparatus 100

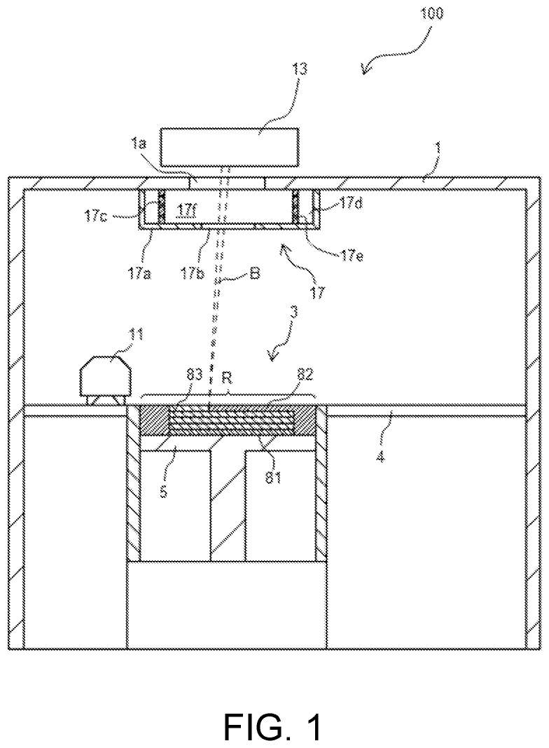

FIG. 1 is a schematic configuration diagram of an additive manufacturing apparatus 100 according to the present embodiment. The additive manufacturing apparatus 100 includes a chamber 1, a material layer forming device 3, and an irradiator 13. By repeatedly forming a material layer 82 and a solidified layer 83 in a build area R provided on a build table 5 arranged in the chamber 1, a desired three-dimensional object is formed.

1.1. Chamber 1

The chamber 1 covers the build area R being an area in which the three-dimensional object is formed. The inside of the chamber 1 is filled with an inert gas of a predetermined concentration supplied from an inert gas supply device (not illustrated). In this specification, the inert gas is a gas that does not substantially react with the material layer 82 or the solidified layer 83, and is selected according to the type of material. For example, nitrogen gas, argon gas or helium gas may be used as the inert gas. The inert gas containing a fume generated during formation of the solidified layer 83 is discharged from the chamber 1, has the fume removed therefrom in a fume collector (not illustrated), and then is supplied to the chamber 1 for reuse. The fume collector includes, for example, an electrostatic precipitator or a filter.

A window 1a serving as a transmission window for a laser beam B is provided on an upper surface of the chamber 1. The window 1a is formed of a material capable of transmitting the laser beam B. Specifically, the material of the window 1a may be selected from quartz glass, or borosilicate glass, or a crystal of germanium, silicon, zinc selenide or potassium bromide, according to the type of the laser beam B. For example, in the case where the laser beam B is a fiber laser or a yttrium aluminum garnet (YAG) laser, the window 1b may be formed of quartz glass.

A contamination prevention device 17 is provided on the upper surface of the chamber 1 so as to cover the window 1a. The contamination prevention device 17 includes a housing 17a of a cylindrical shape, and a diffusing member 17c of a cylindrical shape arranged inside the housing 17a. An inert gas supplying space 17d is provided between the housing 17a and the diffusing member 17c. An opening part 17b is provided on a bottom surface of the housing 17a inside the diffusing member 17c. A large number of pores 17e are provided in the diffusing member 17c, and a clean inert gas supplied to the inert gas supplying space 17d fills a clean room 17f through the pores 17e. The clean inert gas that fills the clean room 17f is ejected toward below the contamination prevention device 17 through the opening part 17b. By such a configuration, the fume can be prevented from adhering to the window 1a and can be removed from an irradiation path of the laser beam B.

1.2. Material Layer Forming Device 3

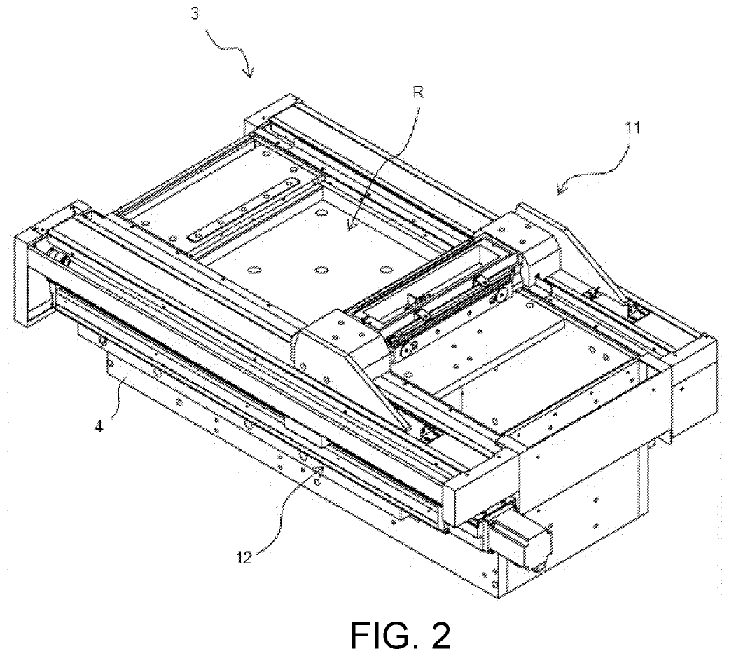

As illustrated in FIG. 1, the material layer forming device 3 is provided inside the chamber 1. As illustrated in FIG. 2, the material layer forming device 3 includes a base 4, and a recoater head 11 arranged on the base 4. The recoater head 11 is configured to be able to reciprocate in a horizontal uniaxial direction by a recoater head drive device 12.

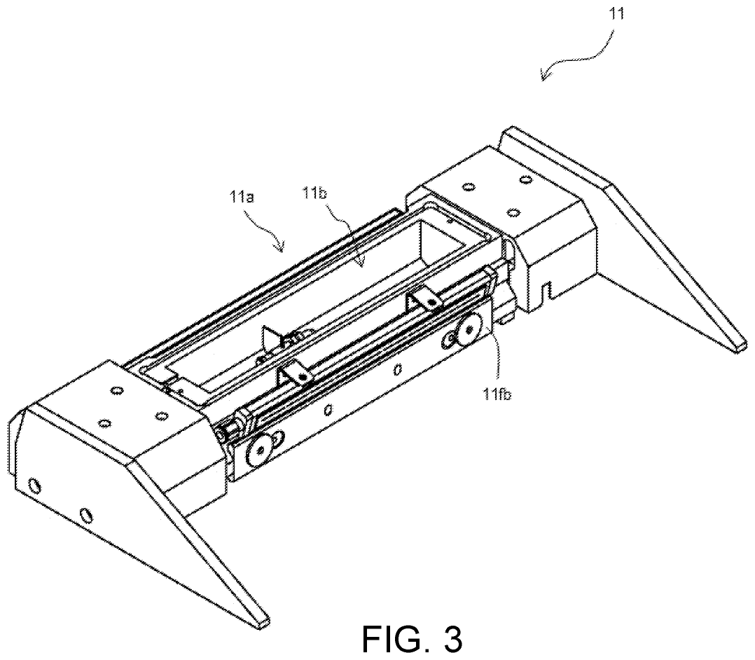

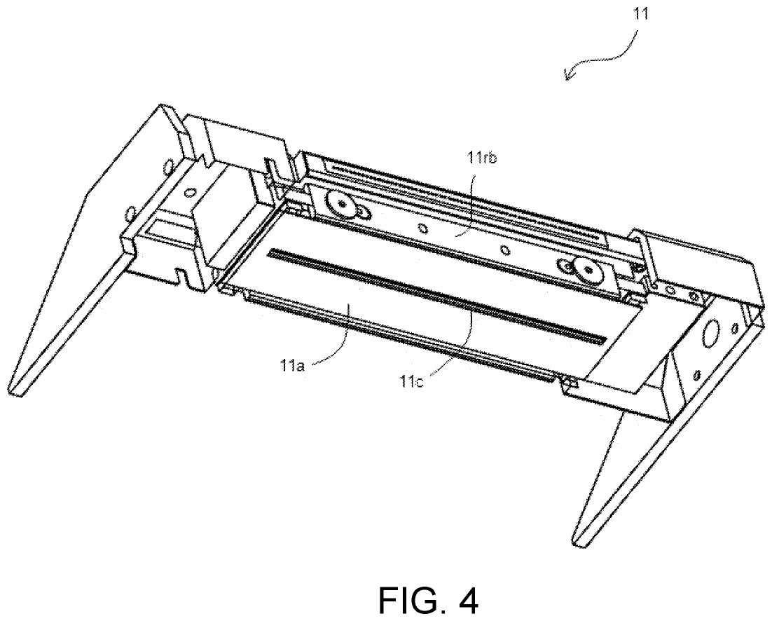

As illustrated in FIG. 3 and FIG. 4, the recoater head 11 includes a material container 11a, a material supply port 11b, and a material discharge port 11c. The material supply port 11b is provided on an upper surface of the material container 11a and serves as a receiving port for material powder supplied from a material supply unit (not illustrated) to the material container 11a. The material discharge port 11c is provided on a bottom surface of the material container 11a and discharges the material powder in the material container 11a. The material discharge port 11c has a slit shape extending in a longitudinal direction of the material container 11a. A blade 11fb and a blade 11rb, both of which are of a flat plate shape, are provided respectively on both side surfaces of the recoater head 11. The blades 11fb and 11rb flatten the material powder discharged from the material discharge port 11c, and the material layer 82 is formed.

As illustrated in FIG. 1 and FIG. 2, the build area R is located on the build table 5, and the desired three-dimensional object is formed in the build area R. The build table 5 is driven by a build table drive device 51 and is movable in a vertical direction. During manufacturing, a base plate 81 is arranged within the build area R, the material powder is supplied onto an upper surface of the base plate 81, and the material layer 82 is formed.

1.3. Irradiator 13

As illustrated in FIG. 1, the irradiator 3 is provided above the chamber 11. The irradiator 13 irradiates an irradiation area in the material layer 82 formed within the build area R with the laser beam B, melts or sinters and solidifies the material powder to form the solidified layer 83.

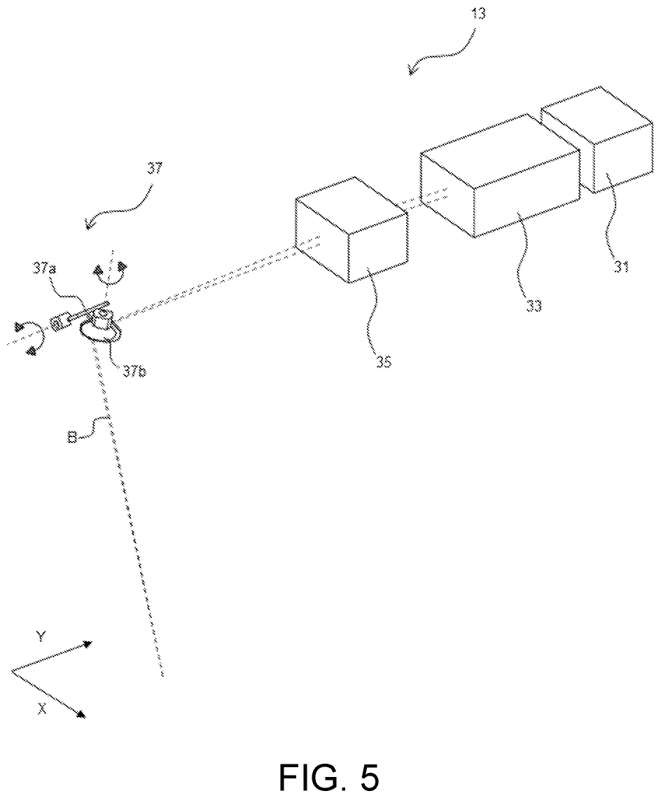

As illustrated in FIG. 5, the irradiator 13 includes a beam source 31, a collimator 33, a focus control unit 35, and a scanner 37, and is controlled by an irradiation control device 72 described later. The beam source 31 generates the laser beam B. It suffices if the laser beam B is able to sinter or melt the material powder, and the laser beam B may be a fiber laser, a CO 2 laser, or a YAG laser. A fiber laser is used as the laser beam B in the present embodiment.

The collimator 33 includes a collimator lens, and converts the laser beam B output from the beam source 31 into parallel light. The focus control unit 53 includes a focus control lens, and a motor that moves the focus control lens back and forth along an optical axis direction. The focus control unit 53 adjusts a focal position of the laser beam B converted into parallel light by the collimator 33, thereby adjusting a beam diameter of the laser beam B on a surface of the material layer 82.

The scanner 37 is, for example, a galvanometer scanner, and includes a first galvanometer mirror 37a, a second galvanometer mirror 37b, as well as a first actuator and a second actuator (both not illustrated) that respectively rotate the first galvanometer mirror 37a and the second galvanometer mirror 37b to a desired angle. The laser beam B that has passed through the focus control unit 35 is two-dimensionally scanned over an upper surface of the material layer 82 within the build area R by the first galvanometer mirror 37a and the second galvanometer mirror 37b. Specifically, the laser beam B is reflected by the first galvanometer mirror 37a, is reflected by the second galvanometer mirror 37b in an X-axis direction being a horizontal uniaxial direction in the build area R, and is scanned in a Y-axis direction being another horizontal uniaxial direction in the build area R and orthogonal to the X-axis direction.

The laser beam B reflected by the first galvanometer mirror 37a and the second galvanometer mirror 37b is transmitted through the window 1a and irradiated onto the material layer 82 within the build area R. Accordingly, the solidified layer 83 is formed. The irradiator 13 is not limited to the above-described form. For example, an fθ lens may be provided in place of the focus control unit 35. The irradiator 13 may be configured to irradiate an electron beam instead of the laser beam B to solidify the material layer 82. Specifically, the irradiator 13 may be configured to include a cathode electrode emitting electrons, an anode electrode converging and accelerating electrons, a solenoid forming a magnetic field and converging directions of the electron beam into one direction, and a collector electrode electrically connected to the material layer 82 being an irradiated body and applying a voltage between itself and the cathode electrode.

1.4. Control System

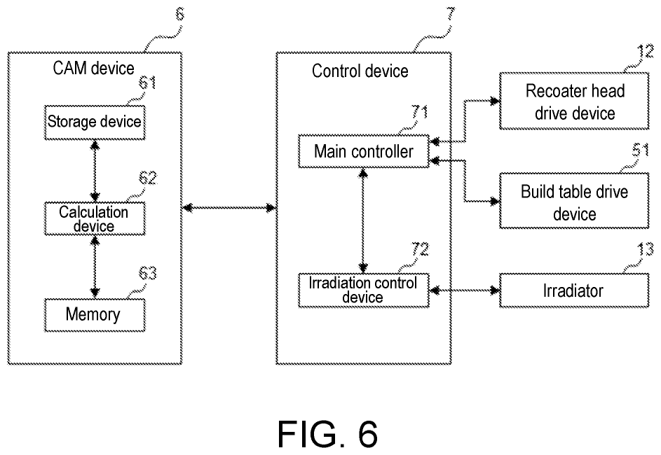

As illustrated in FIG. 6, a control system of the additive manufacturing apparatus 100 includes a computer-aided manufacturing (CAM) device 82 and a control device 7. The CAM device 6 and the control device 7 are configured by arbitrarily combining software with hardware such as a central processor unit (CPU), a random access memory (RAM), a read only memory (ROM), an auxiliary storage device or an input/output interface.

In the CAM device 6, based on manufacturing shape data such as CAD data that specifies a shape of the three-dimensional object, material of the material powder, and an irradiation condition of the laser beam B, or the like, a project file is created in which a command with respect to the additive manufacturing apparatus 100 is defined. The CAM device 6 includes a calculation device 62 performing a desired calculation, a storage device 61 storing data necessary for calculation or the like, and a memory 63 temporarily storing numerical values or data in the process of calculation processing. The CAM device 6 is configured to be able to transmit the project file to the control device 7 via a communication line or a storage medium.

In accordance with the project file, the control device 7 controls the material layer forming device 3 and the irradiator 13 or the like, and performs additive manufacturing. The control device 7 includes a main controller 71 and the irradiation control device 72. The main controller 71 controls the recoater head drive device 12 or the build table drive device 51 or the like in accordance with the project file created by the CAM device 6. The main controller 71 sends, to the irradiation control device 72, a manufacturing program in the project file that contains a command relating to irradiation with the laser beam B. The irradiation control device 72 controls the irradiator 13 in accordance with the manufacturing program. Specifically, the irradiation control device 72 controls the first actuator and the second actuator to cause the first galvanometer mirror 37a and the second galvanometer mirror 37b to rotate a desired angle and irradiate a predetermined position with the laser beam B. The irradiation control device 72 also controls the beam source 31 to switch the output (laser power) or ON/OFF of the laser beam B, and controls the motor of the focus control unit 35 to adjust the focal position of the laser beam B.

### 2. Raster Scanning

Next, raster scanning of the laser beam B is described. The following description also applies to the case of irradiating an electron beam instead of the laser beam B.

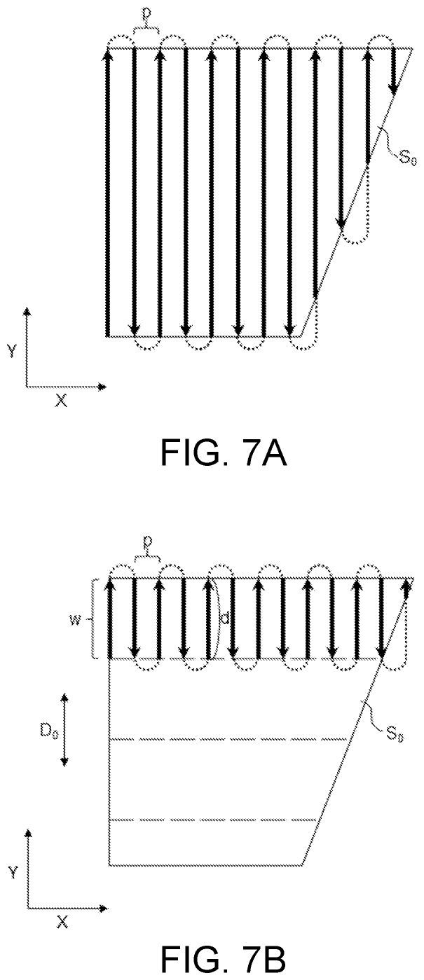

FIG. 7A and FIG. 7B are explanatory diagrams of raster scanning, and illustrate a scan path in the case of performing raster scanning on an exemplary irradiation area S₀. The laser beam B is scanned along a raster scan line indicated by an arrow. The laser beam B is irradiated in an arrow portion, and irradiation with the laser beam B is temporarily stopped for a predetermined time (OFF time) in a dotted line portion connecting adjacent arrows. The OFF time is a time during which irradiation with the laser beam B is temporarily stopped from completion of irradiation of a predetermined raster scan line to commencement of irradiation of the next raster scan line, and is secured in order to suppress a thermal effect on the surroundings in association with irradiation with the laser beam B.

When the laser beam B is irradiated along the raster scan line, an irradiated portion experiences a sharp temperature rise, the material powder is melted, and a melt pool is formed. When irradiation of the portion is ended, the temperature is lowered by heat radiation, and the solidified layer 83 is formed.

In raster scanning by an area non-dividing method illustrated in FIG. 7A, a raster scan line is set every pitch p along a predetermined scanning direction within the irradiation area S₀. The raster scan line is in the shape of a straight line connecting two points on an outer edge of the irradiation area S₀ along the scanning direction, and scanning progresses along a direction orthogonal to the raster scan line.

In raster scanning by an area dividing method illustrated in FIG. 7B, first, the irradiation area S₀ is divided into a plurality of divided areas by a division width w along a division direction D₀. A dashed line in FIG. 7B indicates a division line of the irradiation area. A raster scan line is set at every pitch p along the predetermined scanning direction within the divided area. Within the divided area, scanning progresses along the direction orthogonal to the raster scan line while irradiation with the laser beam B along the raster scan line is repeated. When the scanning within the divided area is completed, another divided area is irradiated with the laser beam B by the same scanning.

In the area dividing method, since the raster scan lines basically have the same reference length d according to the division width w, it is possible to melt and solidify the material layer 82 under relatively uniform conditions without changing the irradiation condition. In the example of FIG. 7B, since the scanning direction is set parallel to the division direction D₀, the reference length d is equal to the division width w, and the length of most raster scan lines is equal to the reference length d. Since the raster scan line is shorter than that in the area non-dividing method, it is possible to suppress a thermal effect of the irradiated portion on the surroundings.

On the other hand, a raster scan line shorter than the reference length d may occur at an end of the divided area. In FIG. 7B, the raster scan line shorter than the reference length d occurs at an end on the right side of each divided area in the drawing and in the divided area on the lower side in the drawing. In a portion irradiated according to the raster scan line shorter than the reference length d, the temperature of the melt pool formed by irradiation with the laser beam B becomes relatively high, and deformation of the solidified layer 83 is likely to occur. When the portion irradiated according to the raster scan line shorter than the reference length d is repeated in the vertical direction as the solidified layer 83 is laminated, accumulation of deformation of the solidified layer 83 increases the size of a bulge, and the blades 11fb and 11rb of the material layer forming device 3 are likely to collide.

Such a bulge markedly occurs in the area dividing method in which the raster scan line is relatively short, and is less likely to be a problem in the area non-dividing method in which the raster scan line is relatively long. While it is possible to prevent the temperature of the melt pool from rising by extending the OFF time, a manufacturing time is lengthened and production efficiency is lowered.

In the present embodiment, in the area dividing method, by setting the raster scan line while rotating the division direction of the irradiation area as described later, repetition of the portion irradiated according to the raster scan line shorter than the reference length d in the vertical direction is reduced, and the occurrence of bulges is suppressed.

### 3. Manufacturing Method of Three-Dimensional Object

Next, a manufacturing method of a three-dimensional object using the additive manufacturing apparatus 100 is described. The manufacturing method according to the present embodiment includes a solidified layer forming step of laminating the solidified layer 83 by repeating a material layer forming step and a solidification step. In the material layer forming step, the material powder is supplied to the build area R and the material layer 82 is formed. In the solidification step, by irradiating a predetermined irradiation area in the material layer 82 with the laser beam B or the electron beam, the solidified layer 83 is formed. The manufacturing method according to the present embodiment includes a manufacturing condition setting step, an irradiation area determining step, a dividing step, a scan line setting step, and a rotation angle setting step.

3.1. Solidified Layer Forming Step

The solidified layer forming step includes the material layer forming step and the solidification step. In the material layer forming step of the present embodiment, the material layer 82 made of the material powder is formed in the build area R. In the solidification step of the present embodiment, the predetermined irradiation area in the material layer 82 is irradiated with the laser beam B, and the solidified layer 83 is formed. The material layer forming step and the solidification step are repeatedly performed.

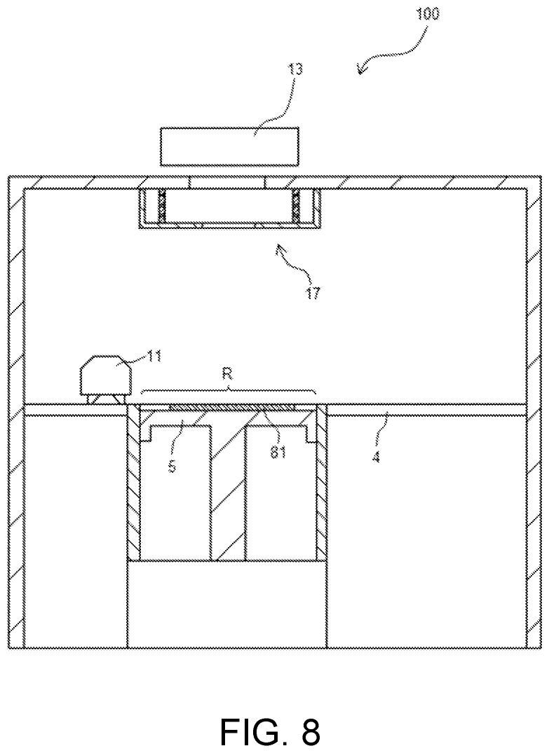

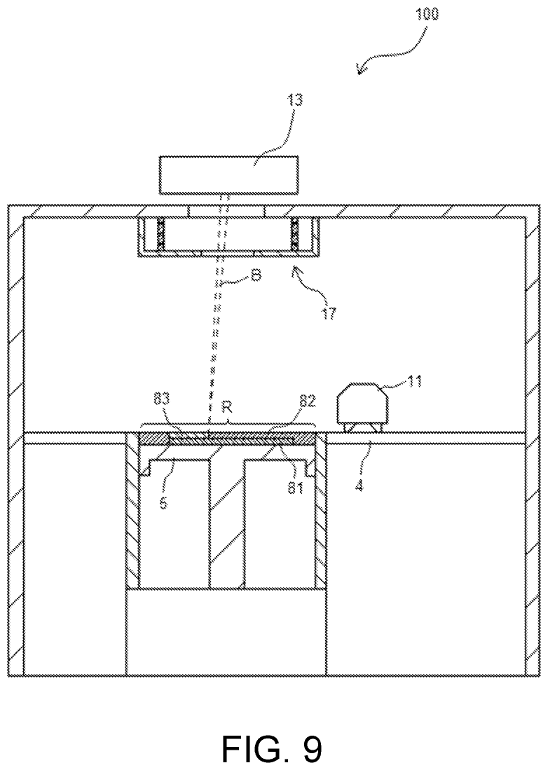

First, the first material layer forming step is performed. As illustrated in FIG. 8, the height of the build table 5 is adjusted to an appropriate position with the base plate 81 placed on the build table 5. By moving the recoater head 11 from the left side to the right side in FIG. 8 in this state, the first material layer 82 is formed on the base plate 81, as illustrated in FIG. 9.

Next, the first solidification step is performed. As illustrated in FIG. 9, by irradiating a predetermined irradiation area in the first material layer 82 with the laser beam B, the first material layer 82 is solidified to obtain the first solidified layer 83. In the solidification step, the laser beam B is scanned along a scan path including a raster scan line set in the scan line setting step as described later.

Subsequently, the second material layer forming step is performed. After the first solidified layer 83 is formed, the height of the build table 5 is lowered by one layer of the material layer 82. By moving the recoater head 11 from the right side to the left side of the build area R in FIG. 9 in this state, the second material layer 82 is formed so as to cover the first solidified layer 83. Then, the second solidification step is performed. In the same way as above, by irradiating a predetermined irradiation area in the second material layer 82 with the laser beam B or the electron beam, the second material layer 82 is solidified to obtain the second solidified layer 83.

The material layer forming step and the solidification step are repeated until the desired three-dimensional object is obtained, and a plurality of solidified layers 83 are laminated. Adjacent solidified layers 83 are firmly fixed to each other.

3.2. Manufacturing Condition Setting Step

In the manufacturing condition setting step, an irradiation condition of the laser beam B or the electron beam and a division width of the irradiation area are set as manufacturing conditions. Examples of the irradiation condition include the output (laser power) of the laser beam B, the size of a spot diameter, scanning speed, the OFF time of the laser beam B, and the pitch p of the raster scan line. The division width of the irradiation area is set to a suitable value based on such an irradiation condition. The manufacturing conditions may also include other conditions such as, for example, a lamination thickness of the material layer 82 (thickness of one material layer) to be irradiated with the laser beam B. In the present embodiment, by creating a condition file in which the manufacturing condition is recorded and having the CAM device 6 read the condition file, the irradiation condition is set.

3.3. Irradiation Area Determining Step

In the irradiation area determining step, the irradiation area is determined for each of a plurality of divided layers obtained by dividing a desired three-dimensional shape of a three-dimensional object every predetermined height. In the irradiation area determining step of the present embodiment, the three-dimensional shape is divided every lamination thickness of the material layer 82 set in the manufacturing condition setting step, and a plurality of divided layers are created. The divided layer corresponds to the material layer 82 virtually formed by dividing the three-dimensional shape. In each divided layer, an area that roughly matches an area surrounded by a contour shape of the three-dimensional object is determined as the irradiation area. In the present embodiment, the CAM device 6 performs calculation processing using the CAD data and the condition file, thereby creating the divided layer and determining the irradiation area.

3.4. Dividing Step

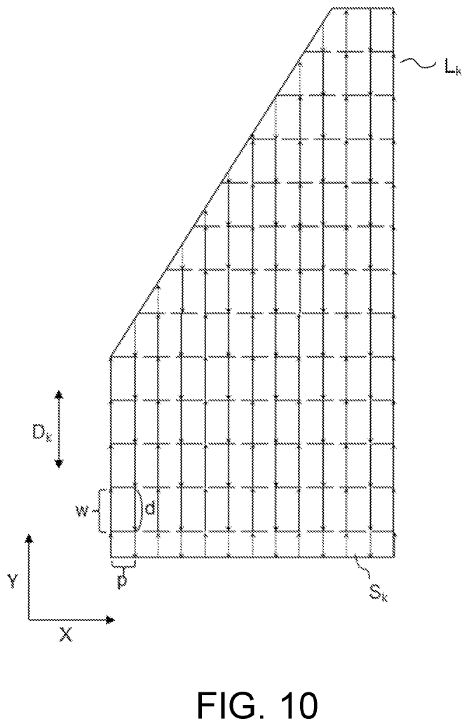

In the dividing step, the irradiation area of each divided layer is divided along a predetermined division direction by the predetermined division width w suitable for the irradiation condition, and a plurality of divided areas are formed. FIG. 10 illustrates, as an example, an irradiation area Sₖ and a divided area thereof in a k-th divided layer Lₖ of the three-dimensional object. In this example, the irradiation area Sₖ is divided by a straight line with the division width w along a division direction Dₖ to form a plurality of divided areas. A dashed line in FIG. 10 indicates a division line of the irradiation area Sₖ. In this example, the division line is in the shape of a straight line orthogonal to the division direction Dₖ. A starting point of division may be appropriately set according to the shape of the irradiation area Sₖ or the like. For example, the starting point may be arranged on or inside an outer edge of the irradiation area Sₖ.

In the dividing step, a direction obtained by horizontally rotating the division direction of the irradiation area in a target divided layer by a rotation angle θ is taken as the division direction of the irradiation area in the divided layer directly above the target divided layer. Here, the rotation angle θ satisfies 0°<θ<180° or −180°<θ<0° (where a sign indicates a rotation direction). A method for setting the rotation angle θ will be described later in details.

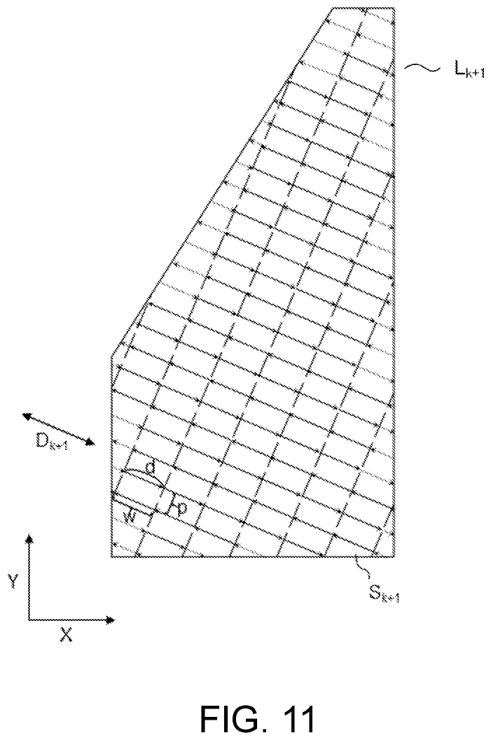

FIG. 11 illustrates, as an example, an irradiation area Sₖ₊₁ and a divided area in a (k+1)-th divided layer Lₖ₊₁ directly above in the case where the k-th divided layer Lₖ is the target divided layer. In this example, a direction obtained by horizontally rotating the division direction Dₖ of the irradiation area Sₖ in the target divided layer Lₖ by the rotation angle θ=67° is taken as a division direction Dₖ₊₁ of the irradiation area Sₖ₊₁ in the divided layer Lₖ₊₁. The irradiation area Sₖ₊₁ is divided by the division width w along the division direction Dₖ₊₁ to form a plurality of divided areas. A dashed line in FIG. 11 indicates a division line of the irradiation area Sₖ₊₁.

In the present embodiment, the division direction is rotated for all the divided layers. That is, when the three-dimensional shape is divided into n divided layers L₁, L₂, L₃, . . . and Lₙ from a lower surface side of the three-dimensional object, and the division direction of the irradiation area in each divided layer is taken as D₁, D₂, D₃, . . . and Dₙ, for the divided layer Lₖ (k=1, 2, 3, . . . and n−1) and the divided layer Lₖ₊₁ directly thereabove, the division direction Dₖ₊₁ is horizontally rotated by the rotation angle θ relative to the division direction Dₖ.

In the present embodiment, the CAM device 6 performs calculation processing using the condition file and the rotation angle θ set in the rotation angle setting step described later on the irradiation area determined in the irradiation area determining step, thereby forming the divided area.

3.5. Scan Line Setting Step

In the scan line setting step, a raster scan line along a predetermined scanning direction is set within a divided area. In FIG. 10 and FIG. 11, as an example, a raster scan line set within the divided area of the divided layers Lₖ and Lₖ₊₁ is indicated by an arrow. In the present embodiment, the scanning direction is set parallel to the division direction. The raster scan line within the divided area is arranged every pitch p set in the manufacturing condition setting step. That is, within the divided area, the raster scan lines parallel to the division direction are arranged at intervals of the pitch p along a division line.

The scanning direction is not limited to this example, and may be set non-parallel to the division direction (for example, to a direction obtained by rotating the division direction by ±45°). A relationship between the scanning direction and the division direction (angle formed by the scanning direction and the division direction) in each divided layer may be the same in all the divided layers, or may be different depending on the divided layer.

Among the raster scan lines illustrated in FIG. 10 and FIG. 11, a solid line portion indicates a raster scan line having the reference length d equal to the division width w, and a dotted line portion indicates a raster scan line shorter than the reference length d. In general, since the irradiation areas of the divided layers adjacent to each other in the vertical direction are similar in shape, when the irradiation areas are divided along the same division direction, portions where the raster scan line shorter than the reference length d is set are likely to be repeated in the vertical direction. On the other hand, in the present embodiment, for the divided layers Lₖ and Lₖ₊₁ adjacent to each other in the vertical direction, by horizontally rotating the division direction Dₖ₊₁ by the rotation angle θ (0=67° in this example) relative to the division direction Dₖ, the portions where the raster scan line shorter than the reference length d is arranged vary, and repetition in the vertical direction is reduced. By rotating the division direction for all the divided layers, the solidified layer 83 can be laminated while repetition of a portion where a short raster scan line is set is reduced. Accordingly, it is possible to suppress the occurrence of bulges due to accumulation of deformation of the solidified layer 83.

In the present embodiment, the CAM device 6 performs calculation processing using the condition file on the divided area formed in the dividing step, thereby setting the raster scan line.

3.6. Rotation Angle Setting Step

In the rotation angle setting step, the rotation angle θ is set based on a machining condition. The machining condition includes at least one of the division width w, material of the material powder, a condition of the irradiation area, an irradiation condition of the laser beam B or the electron beam, and a formation condition of the material layer 82. Based on the machining condition, the rotation angle θ is set so that, in the irradiation area of each divided layer, repetition of the portion where the raster scan line shorter than the reference length d is arranged in the vertical direction is reduced.

When the division direction is sequentially rotated, the division direction matches every predetermined number of divided layers. For example, in the case of the rotation angle θ=±90°, the division direction matches every two layers. From the viewpoint of reducing repetition of the portion where the raster scan line shorter than the reference length d is arranged, a period (number of divided layers) in which the division direction matches is preferably large. From the viewpoint of increasing the period, the rotation angle θ preferably excludes ±90° (that is, 0°<θ<90°, 90°<θ<180°, −180°<θ<−90°, or −90°<θ<0° is satisfied). The rotation angle θ preferably excludes a value whose absolute value |θ| is a divisor of 360. The rotation angle θ is preferably set so that the least common multiple of the absolute value |θ| of the rotation angle θ and 90 is as large as possible.

If the absolute value |θ| of the rotation angle θ is excessively small, or if the rotation angle θ is excessively close to ±180°, the raster scan line shorter than the reference length d in adjacent divided layers has a small amount of change in position, and there is a possibility that the occurrence of bulges cannot be sufficiently suppressed. From such a viewpoint, 40°≤|θ|≤140° is preferable, and 60°≤|θ|≤120° is more preferable.

The machining condition that is taken into account in setting the rotation angle θ is a condition that may affect the occurrence of bulges in the area dividing method. For example, the smaller the division width w, the smaller the reference length d of the raster scan line, and the more likely the bulges are to occur. The likelihood of occurrence of bulges varies depending on the material of the material powder, specifically, depending on conditions such as specific heat capacity of the material. The likelihood of occurrence of bulges varies depending on the condition of the irradiation area, specifically, conditions such as shape or size of the irradiation area. The likelihood of occurrence of bulges varies depending on the irradiation condition of the laser beam B or the electron beam, specifically, conditions such as the output of the laser beam B, the size of a spot diameter, scanning speed, the OFF time of the laser beam B, and the pitch p of the raster scan line. By setting an appropriate rotation angle θ based on these machining conditions in the rotation angle setting step, it is possible to relatively effectively suppress the occurrence of bulges.

### 4. Other Embodiments

The disclosure can also be implemented in the following aspects.

In the above embodiment, the division direction is rotated for all the divided layers in the dividing step. However, the disclosure is not limited to such a configuration. For example, the division direction may be rotated for some of the divided layers according to the shape of the irradiation area or the like.

The manufacturing method of a three-dimensional object may be configured to include a length determining step of determining whether a scan path on a target divided layer includes a raster scan line of less than a predetermined value, and rotation of the division direction may be configured to be performed in the dividing step based on a determination result. In this case, if it is determined in the length determining step that the scan path on the target divided layer includes the raster scan line of less than the predetermined value, in the dividing step, the direction obtained by horizontally rotating the division direction of the irradiation area in the target divided layer by the rotation angle θ is taken as the division direction of the irradiation area in the divided layer directly above the target divided layer.

The predetermined value that serves as a determination criterion is, for example, the reference length d. If it is determined that the scan path on the target divided layer includes the raster scan line of less than the reference length d, the division direction can be rotated and the division direction in the divided layer directly above the target divided layer can be determined. The predetermined value is not limited to this example, and may be set to, for example, a value less than the reference length d.

Various embodiments according to the disclosure have been described above, and these are presented as examples and are not intended to limit the scope of the disclosure. The novel embodiments can be implemented in various other forms, and various omissions, replacements, and changes can be made without departing from the gist of the disclosure. The embodiments and their modifications are included in the scope and gist of the disclosure, and are included in the scope of the disclosure described in the claims and the equivalent scope thereof.

What is claimed is:

1. A manufacturing method of a three-dimensional object, comprising:
in a solidified layer forming step, laminating a solidified layer by repeating a material layer forming step and a solidification step, the material layer forming step comprising supplying material powder to a build area and forming a material layer, the solidification step comprising forming the solidified layer by irradiating a predetermined irradiation area in the material layer with a laser beam or an electron beam;
in a manufacturing condition setting step, setting an irradiation condition of the laser beam or the electron beam and a division width of the irradiation area;
in an irradiation area determining step, determining the irradiation area for each of a plurality of divided layers obtained by dividing a desired three-dimensional shape every predetermined height;
in a dividing step, dividing the irradiation area of each of the plurality of divided layers along a predetermined division direction by the division width suitable for the irradiation condition and forming a plurality of divided areas; and
in a scan line setting step, setting a raster scan line along a predetermined scanning direction within the plurality of divided areas, wherein
in the solidification step, the laser beam or the electron beam is scanned along a scan path comprising the raster scan line;
in the dividing step, a direction obtained by horizontally rotating the division direction of the irradiation area in a target divided layer by a rotation angle θ is taken as the division direction of the irradiation area in the divided layer directly above the target divided layer; and
the rotation angle θ satisfies 0°<θ<180° or −180°<θ<0°, where a sign indicates a rotation direction.

2. The manufacturing method of a three-dimensional object according to claim 1, wherein
in the scan line setting step, the scanning direction is set parallel to the division direction.

3. The manufacturing method of a three-dimensional object according to claim 1, further comprising:
in a length determining step, determining whether the scan path on the target divided layer comprises the raster scan line of less than a predetermined value, wherein
in response to a determination in the length determining step that the scan path on the target divided layer comprises the raster scan line of less than the predetermined value, in the dividing step, the direction obtained by horizontally rotating the division direction of the irradiation area in the target divided layer by the rotation angle θ is taken as the division direction of the irradiation area in the divided layer directly above the target divided layer.

4. The manufacturing method of a three-dimensional object according to claim 1, further comprising:
in a rotation angle setting step, setting the rotation angle θ based on a machining condition, wherein
the machining condition comprises at least one of the division width, material of the material powder, a condition of the irradiation area, and the irradiation condition.
